(19) United States
(12) Patent Application Publication
(10) Pub. No.: US 2025/0276862 A1
(43) Pub. Date: Sep. 4, 2025

(54) DOCK DOOR LEVELER DEVICE

(71) Applicants: John Nacinopa, Las Vegas, NV (US); Israel Ramirez, Las Vegas, NV (US)

(72) Inventors: John Nacinopa, Las Vegas, NV (US); Israel Ramirez, Las Vegas, NV (US)

(21) Appl. No.: 18/594,537

(22) Filed: Mar. 4, 2024

(51) Int. Cl. B65G 69/28; B65G 67/02

(52) U.S. Cl. CPC B65G 69/2876; B65G 67/02

(57) ABSTRACT

A dock door leveler guard is provided that folds out during dock door leveler operations that completely covers the side leveler pit gaps created between the dock door lever and the loading dock on each side thereby preventing injury to a person both from tripping over uneven surfaces and getting their foot caught in the side pit gaps during truck loading and unloading operations The dock door leveler guard comprises a first rectangular component and a second generally triangular component wherein the first rectangular component is connected to the generally triangular component by one or more hinges for allowing the second triangular component to fold out onto the loading dock surface wherein the first rectangular components are attached to each side of the dock door leveler.

### BACKGROUND OF THE INVENTION

### Field of the Invention

This invention relates to a door dock leveler guard mounted to both edges of a door dock leveler which acts as a bridge between a loading dock platform and a door dock leveler and, more particularly, to a door dock leveler guard for operating at the edge of the dock leveler for bridging the gap or space created when a door dock leveler is lowered to the back of a truck relative to an adjacent loading dock platform.

### Prior Art

A dock door leveler device, commonly referred to as a dock leveler, is an essential piece of equipment used in loading docks to bridge the gap between the warehouse or facility floor and the bed of a truck or trailer. Its primary function is to ensure a smooth and safe transition for forklifts, pallet jacks, and personnel moving goods between the dock and the vehicle.

Dock levelers come in various types, including hydraulic, mechanical, and air-powered models, but they all serve the same basic purpose. A dock leveler typically bridges the gap when a truck backs up to the loading dock, as there is often a gap between the dock and the truck bed due to differences in height or variations caused by the suspension of the vehicle. The dock leveler spans this gap, creating a continuous surface for loading and unloading operations.

The space between a dock door leveler and the loading dock is commonly referred to as the “dock leveler pit” or simply the “leveler pit.” This pit is specifically designed to accommodate the dock leveler when it is not in use, allowing it to be stored flush with the loading dock surface when not in operation. The leveler pit helps to ensure a smooth transition for vehicles and equipment moving in and out of the loading dock area and minimizes the risk of tripping hazards or damage to the leveler. Additionally, it provides a secure space for the leveler to retract into, protecting it from potential damage caused by impacts or environmental factors.

However, there exists a side space or another gap along each side of the dock leveler and the loading dock as they are not perfectly matched. The space between a dock door leveler and the loading dock is commonly referred to as the “dock leveler pit” or simply the “leveler pit.” This pit is specifically designed to accommodate the dock leveler when it is not in use, allowing it to be stored as flush as possible with the loading dock surface when not in operation. The leveler pit helps to ensure a smooth transition for vehicles and equipment moving in and out of the loading dock area and minimizes the risk of tripping hazards or damage to the leveler. Additionally, it provides a secure space for the leveler to retract into, protecting it from potential damage caused by impacts or environmental factors.

Overall, a dock leveler device plays a crucial role in maximizing the efficiency and safety of loading dock operations. By providing a smooth transition between the dock and the truck bed, it helps to streamline the flow of goods and minimize the risk of accidents and damage to equipment. Dock levelers are equipped with safety features to prevent accidents and injuries during loading and unloading operations. These may include lip extension plates to bridge the gap between the dock and the truck bed, as well as safety legs or supports to stabilize the leveler and prevent it from collapsing under heavy loads.

What is needed is a dock door leveler guard that folds out during dock door leveler operations that completely covers the side leveler pit gaps on each side thereby preventing injury of a person falling into the gap during truck loading and unloading operations.

### SUMMARY OF THE INVENTION

A dock door leveler guard is provided that folds out during dock door leveler operations that completely covers the side leveler pit gaps created between the dock door lever and the loading dock on each side thereby preventing injury both to a person from tripping over uneven surfaces and getting their foot caught in the side pit gaps during truck loading and unloading operations The dock door leveler guard comprises a first rectangular component and a second generally triangular component wherein the first rectangular component is connected to the generally triangular component by one or more hinges for allowing the second triangular component to fold out onto the loading dock surface wherein the first rectangular components are attached to each side of the dock door leveler.

### BRIEF DESCRIPTION OF DRAWINGS

FIG. 1A is a top view of graphical picture of the right door dock leveler guard in accordance with the present invention;

FIG. 1B is a top view of graphical picture of the right door dock leveler guard in accordance with the present invention;

FIG. 2 is a graphical picture of the door dock leveler guard mounted to a door dock leveler before the door dock leveler is lowered;

FIG. 3 is another graphical picture illustrating the unfolding action of the door dock leveler guard when the door dock lever is being lowered in accordance with the present invention; and

FIG. 4 is yet another graphical picture illustrating the door dock leveler in the lowered position providing a bridge covering a gap between the door dock leveler and the loading dock in accordance with the present invention.

### DETAILED DESCRIPTION OF THE INVENTION

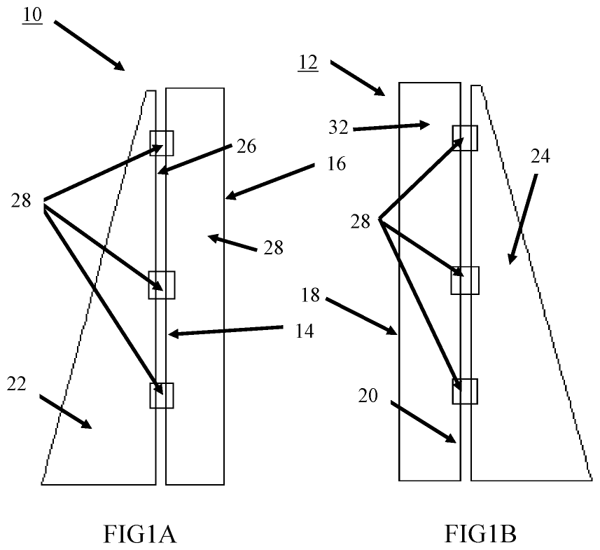

Referring to now FIGS. 1A and 1B there is shown dock door leveler guards 10 and 12 used during truck loading and unloading operations for covering side pit gaps created between a dock door lever and a loading dock surface during dock door lever operations Turning once again to FIGS. 1A and 1B first and second rectangular components 14 and 16 respectively each defining left 18 and right sides 20 and first and second triangular components 22 and 24 respectively each defining a base 26 wherein the right side 20 of said first rectangular component 14 is connected to the base 26 of the first triangular component 22 by one or more hinges 28 forming a right dock door leveler guard 10 as Shown in FIG. 1A, wherein the left side 18 of the second rectangular component 16 is connected to the base 26 of the second triangular component 24 by one or more hinges 28 forming a left dock door leveler guard 12 as shown in FIG. 1B.

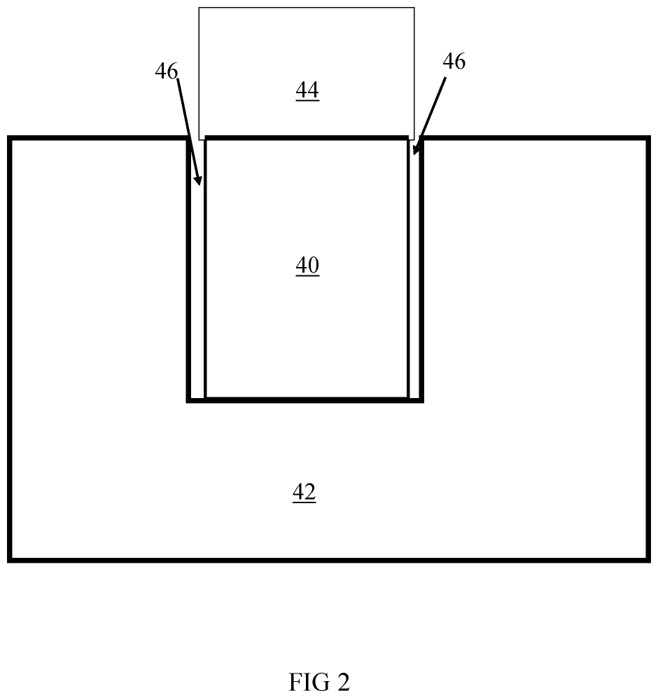

Referring now to FIG. 2, there is shown a top view of a door dock leveler 40 which acts as a bridge between a loading dock platform 42 and the back of a truck 44. It should be understood that in use the dock door leveler 40 moves up and down in a cavity created by the loading dock platform 42 which creates a gap 46 on each side between the door dock leveler 40 and the loading dock 44.

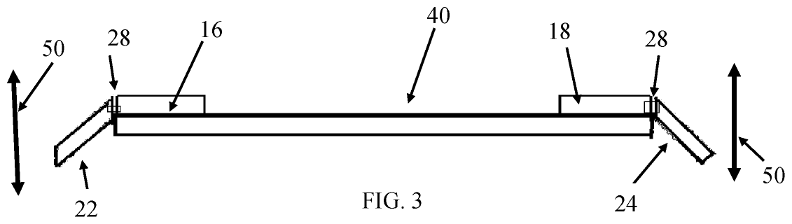

Referring now to FIG. 3 is another graphical picture illustrating the unfolding action of the door dock leveler guards 10 and 12 when the door dock lever 40 is being lowered. More specifically, the right and left dock door leveler guards 10 and 12 respectively, the triangular components 22 and 24 respectively fold out 50 onto the loading dock surface 42 during dock door lever 40 operations thereby preventing injury both to a person from tripping over uneven surfaces and getting their foot caught in the side pit gaps during truck loading and unloading operations.

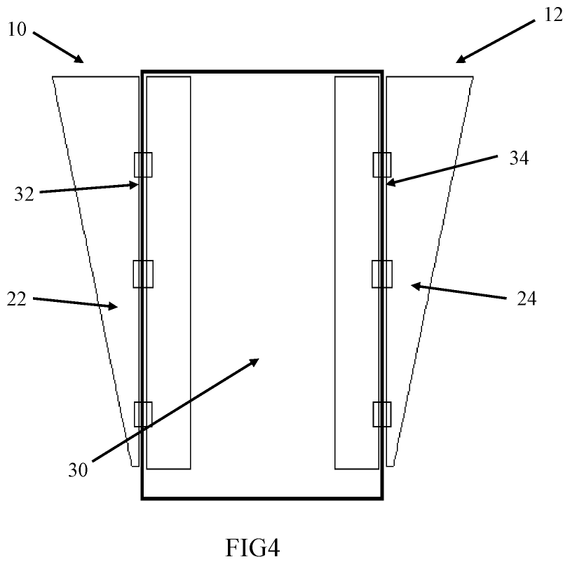

Referring now to FIG. 4 the right and left dock door leveler guards and 10 and 12 respectively are attached to the sides 32 and 34 of the loading dock leveler 30. The right first and second triangular components 22 and 24 are located off to the sides of the loading dock leveler and hang free allowing the first and second triangular components to swing up and down during dock door leveler operation.

The first and second rectangular components 14 and 16 are fabricated using an ultra-high molecular weight polyethylene. UHMW (ultra-high molecular weight polyethylene) is an extremely tough plastic with high abrasion and wear resistance. The versatility of polyethylene has made it a popular plastic for countless industrial applications that require durability, low friction, and chemical resistance.

The first and second triangular components are fabricated using an ultra-high molecular weight polyethylene. The right and left dock door leveler guards components are fabricated using either wood or metal.

The first and second rectangular components are attached to the sides of the loading dock leveler using a plurality of magnets (not shown) located on a bottom of said first and second rectangular components and top of the door dock leveler. The first and second rectangular components are attached to the sides of the loading dock leveler using double back sticky tape (not shown) located on a bottom of said first and second rectangular components and top of the door dock leveler. wherein there are 3 said hinges.

While the invention has been described in detail and with reference to specific embodiment thereof, it will be apparent to one skilled in the art that various changes and modifications can be made therein without departing from the spirit and scope thereof.

What is claimed is:

1. Dock door leveler device used during truck loading and unloading operations for covering side pit gaps created between a dock door lever and a loading dock surface during dock door lever operations, comprising:
first and second rectangular components each defining left and right sides, first and second triangular components each defining a base, and;
said right side of said first rectangular component is connected to said base of said first triangular component by one or more hinges forming a right dock door leveler guard, and;
said left side of said second rectangular component is connected to said base of said second triangular component by one or more hinges forming a left dock door leveler guard, whereby said right and left dock door leveler guards fold out onto the loading dock surface during dock door lever operations thereby preventing injury both to a person from tripping over uneven surfaces and getting their foot caught in the side pit gaps during truck loading and unloading operations.

2. The right and left dock door leveler guards according to claim 1 wherein right and left dock door leveler guards have said first and second rectangular components are attached to the sides of the loading dock leveler.

3. The right and left dock door leveler guards according to claim 1 wherein said first and second triangular components are located off to the sides of the loading dock leveler and hang free allowing said first and second triangular components to swing up and down during dock door leveler operation.

4. The right and left dock door leveler guards according to claim 1 wherein said first and second rectangular components are fabricated using an ultra-high molecular weight polyethylene.

5. The right and left dock door leveler guards according to claim 1 wherein said first and second triangular components are fabricated using an ultra-high molecular weight polyethylene.

6. The right and left dock door leveler guards according to claim 1 wherein said first and second rectangular components are fabricated using wood.

7. The right and left dock door leveler guards according to claim 1 wherein said first and second triangular components are fabricated using wood.

8. The right and left dock door leveler guards according to claim 1 wherein said first and second rectangular components are fabricated using metal.

9. The right and left dock door leveler guards according to claim 1 wherein said first and second triangular components are fabricated using metal.

10. The right and left dock door leveler guards according to claim 1 wherein said first and second rectangular components are attached to the sides of the loading dock leveler using a plurality of magnets located on a bottom of said first and second rectangular components and top of the door dock leveler.

11. The right and left dock door leveler guards according to claim 1 wherein said first and second rectangular components are attached to the sides of the loading dock leveler using double back sticky tape located on a bottom of said first and second rectangular components and top of the door dock leveler.

12. The right and left dock door leveler guards according to claim 1, wherein there are 3 said hinges.

13. A method for covering side pit gaps created between a dock door lever and a loading dock surface during dock door lever operations, comprising:
connecting using hinges a right elongated side of a first rectangular component to a base of a first triangular component forming a right dock door leveler guard, and;
connecting using hinges a left elongated side of a second rectangular component to a base of a second triangular component forming a left dock door leveler guard, and;
attaching said first and second rectangular components to the sides of the loading dock leveler, and;
covering the side pit gaps when said right and left dock door leveler guards fold out onto the loading dock surface during dock door lever operations thereby preventing injury to a person from tripping over uneven surfaces and getting their foot caught in the side pit gaps during truck loading and unloading operations.

14. The method for covering side pit gaps according to claim 13, further comprising
attaching said first and second rectangular components to the sides of the loading dock leveler.

15. The right and left dock door leveler guards according to claim 13 further comprising;
locating said first and second triangular components off to the sides of the loading dock leveler allowing said first and second triangular components to hang free and swing up and down during dock door leveler operation.

16. The method for covering side pit gaps according to claim 13 further comprising
fabricating said first and second rectangular components using an ultra-high molecular weight polyethylene.

17. The method for covering side pit gaps according to claim 13 further comprising
fabricating said first and second triangular components using an ultra-high molecular weight polyethylene.

18. The method for covering side pit gaps according to claim 13 further comprising
attaching said first and second rectangular components are to the sides of the loading dock leveler using a plurality of magnets located on a bottom of said first and second rectangular components and top of the door dock leveler.

19. The method for covering side pit gaps according to claim 1 further comprising
attaching said first and second rectangular components to the sides of the loading dock leveler using double back sticky tape located on a bottom of said first and second rectangular components and top of the door dock leveler.

20. Dock door leveler guards used during truck loading and unloading operations for covering side pit gaps created between a dock door lever and a loading dock surface during dock door lever operations, comprising:
first and second rectangular components each defining left and right sides, first and second triangular components each defining a base, and;
said right side of said first rectangular component is connected to said base of said first triangular component by one or more hinges forming a right dock door leveler guard, and;
said left side of said second rectangular component is connected to said base of said second triangular component by one or more hinges forming a left dock door leveler guard wherein said first and second rectangular components are attached to the sides of the loading dock leveler wherein said first and second triangular components are located off to the sides of the loading dock leveler and hang free allowing said first and second triangular components to swing up and down during dock door leveler operation, and;
whereby said right and left dock door leveler guards fold out onto the loading dock surface during dock door lever operations thereby preventing injury to a person both from tripping over uneven surfaces and getting their foot caught in the side pit gaps during truck loading and unloading operations.
